(19) United States
(12) Patent Application Publication
(10) Pub. No.: US 2018/0232649 A1
(43) Pub. Date: Aug. 16, 2018

(54) EFFICIENT ONLINE METHODS FOR QUANTUM BAYESIAN INFERENCE

(71) Applicant: Microsoft Technology Licensing, LLC, Redmond, WA (US)

(72) Inventors: Nathan Wiebe, Redmond, WA (US); Christopher Granade, Sydney (AU)

(73) Assignee: Microsoft Technology Licensing, LLC, Redmond, WA (US)

(21) Appl. No.: 15/751,842

(22) PCT Filed: Jul. 21, 2016
(86) PCT No.: PCT/US2016/043228

§ 371 Date: Feb. 9, 2018

Related U.S. Application Data
(60) Provisional application No. 62/203,356, filed on Aug. 10, 2015.

(51) Int. Cl. G06N 7/00; G06N 99/00; G06F 17/16; G06F 17/14

(52) U.S. Cl. CPC G06N 7/005; G06F 17/14; G06F 17/16; G06N 99/002

(57) ABSTRACT

Quantum methods for Bayesian inference represent prior or current posterior distributions with a series of qubits. A rotation gate defined by a rotation angle based on the prior or current posterior is applied to a selected qubit of the series. The selected qubit is measured, and if measurement is successful, the state of the series of qubits represents a posterior or updated posterior. If the measurement is unsuccessful, the representation of the prior or current posterior in the series of qubits, the rotation operation, and the measurement operations are repeated until success. A sinc² based model distribution is obtained using a quantum Fourier transform (QFT), and, in some cases, a QFT is also used to implement convolution in a filtering operation for inference with time-dependent systems.

### FIELD

The disclosure pertains to quantum Bayesian inference.

### BACKGROUND

Data processing has emerged within the last few years to be a problem of central importance within both academic circles and industry. The need for ever more sophisticated methods for processing data arose from the fact that modern experiments produce huge amounts of data and properly inferring information from huge data sets can require substantial computational power. One significant approach for inferring information from large data sets is Bayesian inference, which is generally computationally expensive, especially for scientific applications. Perhaps the biggest contributor to the cost of Bayesian inference algorithms is the dimensionality of the model space. Typically, performing an update to a likelihood requires integrating over an infinite number of hypotheses. Such integrals are typically intractable, limiting the applicability of Bayesian inference. In addition, the computation of likelihood functions is often intractable. For these reasons, Bayesian inference methods are often impractical.

### SUMMARY

Disclosed herein are methods and apparatus that use quantum computations that permit substantial reductions in computational resources needed to perform Bayesian inference. In typical examples, a set of experimental or other data is obtained, and a prior distribution (or current posterior distribution) associated with the experiment or measurement is obtained. The prior distribution is represented in a quantum register, and a rotation gate is applied to a selected qubit of the quantum register. The state of the selected qubit is measured, and depending on the measurement, the quantum register is associated with an updated posterior, or the prior distribution is represented in the quantum register again. The rotation and measurement operations are repeated until an updated posterior is obtained. This update process can be repeated to produce a final posterior. In some cases, qubit representations of sinc functions are used to estimate distributions, and convolutions of a distribution with a model distribution are determined using quantum computations to permit Bayesian inference for time-varying systems.

### BRIEF DESCRIPTION OF THE DRAWINGS

FIG. 1 illustrates error as a function of a number of Bayes updates for Gaussian resampling and sinc² resampling.

FIG. 2 illustrates a representative quantum circuit that produces a linear combination of step functions.

FIG. 3 is a block diagram illustrating quantum rejection sampling.

FIG. 4 illustrates a Hadamard test procedure.

FIG. 5 illustrates an approximate update method for Bayesian inference,

FIG. 6 illustrates a quantum method of sinc function preparation.

FIG. 7 illustrates a filter method that is suitable for time-dependent inference.

FIG. 8 illustrates a method of computing a gradient of a utility function using quantum rejection sampling.

FIG. 9 illustrates a procedure for determination of a gradient of a particular utility function.

FIG. 10 is a block diagram of a representative computing environment that includes classical and quantum processing.

FIG. 11 illustrates a representative classical computer that is configured to specify gates and procedures for Bayesian inference and quantum rejection sampling as well as associated classical procedures.

### DETAILED DESCRIPTION

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

In some examples, values, procedures, or apparatus' are referred to as “lowest”, “best”, “minimum,” or the like. It will be appreciated that such descriptions are intended to indicate that a selection among many used functional alternatives can be made, and such selections need not be better, smaller, or otherwise preferable to other selections.

Disclosed herein are methods and apparatus that apply quantum computing techniques to statistical inference and generally offer superior performance than conventional classical methods. In particular, the disclosure pertains to quantum-based Bayesian inference.

As used herein, terms such as “cost” and “efficiency” are used to refer to computational complexity, typically to demonstrate that methods or apparatus can be practically implemented, and can improve the functioning of computing systems. An initial or prior distributions is referred to herein in some cases as a current posterior distribution or likelihood for simplicity in describing methods for updating distributions which can generally be used to update a prior or a current likelihood. In some cases, specific orderings of qubits and specific states are used for convenient description. Different arrangements and states can be used.

The disclosure generally pertains to methods and apparatus for performing Bayesian inference on a quantum computer using quantum rejection sampling. The disclosed approaches typically permit Bayesian inference to be performed on a quantum computer with high probability of success, unlike conventional approaches. Quantum rejection sampling is used to refine a set of N samples drawn from an initial prior distribution into a set of at most N samples that approximate samples drawn from a posterior distribution (which is the updated distribution over potential hypotheses that describe could model a device given some observation of the system). A classical description of the posterior distribution is obtained and can be used if the quantum-based methods and apparatus fail. This permits significant reduction in computation time and complexity.

In some examples, the disclosed methods and apparatus are applied to systems having a time-dependent likelihood function. In these and other examples, the disclosed methods can be used to estimate experiments to perform given a current prior distribution. Such methods can substantially reduce the number of experiments needed and increase the stability of Bayesian inference.

According to some specific embodiments, quantum Bayesian inference is performed using quantum rejection sampling and an inference procedure so as to estimate an approximate form for a quantum posterior distribution. Amplitude estimation can be used to inexpensively evaluate the parameters of the approximation. Quantum posterior distributions can be filtered using quantum Fourier transforms to implement a convolution to allow inference of time dependent models. Quantum circuits based on quantum Fourier transforms can be configured to prepare sinc² probability distributions for approximating the prior distribution, and quantum methods for finding appropriate or optimal experiments can be provided.

In most cases, a sample is drawn from an initial easy to prepare distribution and then that sample is either accepted or rejected with a fixed probability dependent upon the ratio of the probability ascribed to the sample from the true distribution and that given to it by the distribution that can be efficiently sampled from. The accepted samples are then distributed according to the true distribution rather than the elementary distribution from which they were drawn.

This sampling procedure can be applied directly to sampling from a Gibbs distribution and in turn to training Boltzmann machines or to Bayesian inference. The procedure for Bayesian inference follows the same sampling logic, except that after each sampling step a model of the resultant distribution is inferred from the samples drawn. This model is then used as the initial easy to prepare distribution in subsequent steps and is then refined into increasingly accurate models by repeating this process. The disclosed approaches typically require less memory than other methods for Bayesian inference and can also provide more accurate approaches to Gibbs sampling and training Boltzmann machines.

### Overview

Bayes' rule gives the correct way to update a prior distribution that describes an experimentalist's initial beliefs about a system model when a piece of experimental evidence is received. If E is a piece of evidence and x denotes a candidate model for the experimental system, then Bayes' rule states that the probability that the model is valid given the evidence P(x|E) is:

$$P ( x \vert E ) = \frac{P ( E \vert x ) P ( x )}{{\int }_{x} P ( E \vert x ) P ( x ) dx} = \frac{P ( E \vert x ) P ( x )}{〈 P ( E \vert x ) , P ( x ) 〉} ,$$

wherein P(E|x) is referred to as a likelihood function (or likelihood). P(x|E) is also referred to as a posterior probability distribution or simply as a posterior.

### Bayes' Rule and Rejection Sampling

For purposes of illustration, it is assumed that there is a quantum oracle O_{E}|x [symbol] |0 [symbol] =|x [symbol] |P(E|x) [symbol] that computes a likelihood function as a bit string in a quantum register and that there is a constant Γ_{E} such that P(E|x)≤Γ_{E}≤1 for all x. Then, given an initial state

$${\sum }_{x} \sqrt{P ( x )} \vert x 〉$$

and Γ_{E}:P(E|x)≤Γ_{E}, a Bayesian update can be performed on the state with probability at least [symbol] w,P(E|x) [symbol] Γ_{E} using one query to the quantum oracle. Using a single call to O_{E} and adding a sufficient number of ancilla qubits, the state

$${\sum }_{x} \sqrt{P ( x )} \vert x 〉$$

is transformed into

$${\sum }_{x} \sqrt{P ( x )} \vert x 〉 \vert P ( E \vert x ) 〉 \vert 0 〉 .$$

By adding a qubit and applying a rotation operation R_{y}(2 sin⁻¹(P(E|x)/Γ_{E})), the following transformation is obtained:

$${\sum }_{x} \sqrt{P ( x )} \vert x 〉 \vert P ( E \vert x ) 〉 \vert 0 〉 ↦ {\sum }_{x} \sqrt{P ( x )} \vert x 〉 \vert P ( E \vert x ) 〉 ( \sqrt{\frac{P ( E \vert x )}{{Γ}_{E}}} \vert 1 〉 + \sqrt{1 - \frac{P ( E \vert x )}{{Γ}_{E}}} \vert 0 〉 ) .$$

Then, if the right most qubit register is measured and a result of 1 is obtained, the resultant state is:

$$\frac{{\sum }_{x} \sqrt{P ( x ) P ( E \vert x )} \vert x 〉}{\sqrt{{\sum }_{x} {w}_{x} P ( E \vert x )}}$$

which gives a probability distribution that corresponds to that expected by Bayes' rule. The probability of this occurring is

$${\sum }_{x} P ( x ) P ( E \vert x ) / {Γ}_{E} .$$

If the Bayesian algorithm is used solely to post-process information then one update will suffice to give the posterior distribution. In settings where experiments are chosen in an online fashion, then many updates will be needed to reach the final posterior distribution. If L updates are required then the probability of success is:

$${P}_{succ} \geq {\sum }_{x} P ( x ) {( {min}_{E} \frac{P ( E \vert x )}{{Γ}_{E}} )}^{L} .$$

In such cases the success probability can drop exponentially. This can be combated by using amplitude amplification on the condition that all L updates are successful, but this is generally insufficient to eliminate the exponentially shrinking success probability. This reduces the expected number of updates needed to:

$$O ( {( {\sum }_{x} P ( x ) {( {min}_{E} \frac{P ( E \vert x )}{{Γ}_{E}} )}^{L} )}^{- 1 / 2} ) .$$

Assuming that the norm of the covariance matrix for x is a constant, then the posterior mean (an unbiased estimator of the true model) can be computed to within error δ using the following number of samples:

$$O ( {( {\sum }_{x} P ( x ) {( {min}_{E} \frac{P ( E \vert x )}{{Γ}_{E}} )}^{L} )}^{- 1 / 2} {δ}^{- 2} ) .$$

Approximations are often needed to make both classical as well as quantum Bayesian inference tractable. However, the purpose of these approximations is very different. Classical methods struggle when dealing with probability distributions in high-dimensional spaces, and sophisticated methods like sequential Monte-Carlo (SMC) approximations are often employed to reduce the effective dimension. However, the non-linear nature of the update rule and the problem of extracting information from the posterior distribution are not issues. Quantum algorithms generally have the exact opposite strengths and weaknesses: quantum methods can easily cope with exponentially large spaces but struggle to emulate non-linear update rules. This can be addressed by making quantum methods a bit classical, meaning that through-out the learning process, an approximate classical model for the posterior is obtained alongside the quantum algorithm. This classical model allows approximate re-preparation of the quantum state should an update fail throughout the updating process. This removes the exponential scaling, but results in an approximate inference. Such methods can be referred to as quantum resampling methods. The posterior distribution can be modeled as a Gaussian distribution with mean and covariance equal to that of the true posterior. With this choice, once the Gaussian distribution is specified, the Grover-Rudolph state preparation method can be used to prepare such states as their cumulative distribution functions can be efficiently computed. Alternatively, for one-dimensional problems, such states could be manufactured by approximate cloning. A representative method of measuring expectation values and a covariance matrix of a posterior is illustrated below.

### Hadamard Test

Given a unitary operator U such that

$$U \vert 0 〉 = {\sum }_{x} P ( x ) \vert x 〉$$

and an observable

$$Λ = {\sum }_{x} {λ}_{x} \vert x 〉 〈 x \vert$$

and an estimate λ₀:maxₓ|λₓ−λ₀|≤Δλ, there exists a quantum algorithm to estimate ( [symbol] ψ|Λ|ψ [symbol] −λ₀) within error ϵ with probability at least 8/π² using Õ(Δλ/ϵ) applications of U and queries to an oracle O_{λ} such that O_{λ}|x [symbol] |0 [symbol] =|x [symbol] |λₓ [symbol] . The observable can correspond to a position, a standard deviation, a mean, or other observable, including other characteristics of a distribution.

An estimate can be obtained by preparing the following state (typically, using one query to O_{λ} and one application of U):

$${\sum }_{x} \sqrt{\frac{P ( x )}{2}} \vert x 〉 \vert {λ}_{x} 〉 ( \sqrt{1 + \frac{{λ}_{x} - {λ}_{0}}{Δ λ}} \vert 1 〉 + \sqrt{1 - \frac{{λ}_{x} - {λ}_{0}}{Δ λ}} \vert 0 〉 ) \qquad ( 1 )$$

The probability of measuring 1 is:

$${\sum }_{x} \frac{P ( x )}{2} ( 1 + \frac{{λ}_{x} - {λ}_{0}}{Δ λ} ) = \frac{1}{2} + \frac{〈 ψ \vert Λ \vert ψ 〉 - {λ}_{0}}{2 Δ λ} \qquad ( 2 )$$

This probability can be learned within additive error δ using O(1/δ²) samples and hence [symbol] ψ|Λ|ψ [symbol] −λ₀ can be learned within error ϵ using O(Δλ²/ϵ²) samples.

This probability can also be learned using amplitude estimation. In amplitude estimation, a set of states is marked in order to estimate the probability of measuring a state within that set. In this case, all states are marked in which a right-most qubit is 1. Amplitude estimation then uses O(1/δ) queries to U and the above state preparation method above to estimate the probability to within error δ and store it in a qubit register. Amplitude estimation has a probability of success of at least 8/π² so that Õ(1/δ) queries are needed to achieve arbitrarily large success probability.

The above illustrates a method for learning not just a mean of a posterior distribution but also a standard deviation. This allows inference of a two parameter model for a posterior distribution in cases where the model is one-dimensional. In particular, using λₓ=x yields the mean x₀. The variance can then be computed by assigning λₓ=(x−x₀)². This approach can be generalized to higher dimensions, and is not restricted to a single variable (x).

Representing the components of the mean of the prior distribution over model vectors as {λ^{(j)}:j=1 . . . D} and Δλ≥maxⱼ| [symbol] Λ^{(j)} [symbol] −λ^{(j)}|, then the mean and covariance matrix can be computed within error ϵ using

$$\tilde{O} ( \frac{{D}^{2} Δ λ {Γ}_{E}}{ϵ 〈 w , P ( E \vert x ) 〉} )$$

queries to O_{E}. Let

$$P ( 1 ) = {\sum }_{x} P ( x ) P ( E \vert x ) / κ$$

be the probability of performing the Bayesian update and P(11) be the probability of both performing the update, applying the Hadamard test and measuring the right most qubit in Eq. 1 to be 1:

$$P ( 11 ) = \frac{P ( 1 )}{2} ( 1 + \frac{{〈 {Λ}_{k} 〉}_{post} - {λ}_{0 , k}}{Δ λ} ) ,$$

wherein Λₖ is an observable that reports either the k^{th} mean or the k^{th} element of the covariance matrix and [symbol] ⋅ [symbol] ₚₒₛₜ refers to an expectation value of a quantity in the posterior state.

### Therefore,

$${〈 {Λ}_{k} 〉}_{post} = ( 2 \frac{P ( 11 )}{P ( 1 )} - 1 ) Δ λ + {λ}_{0 , k} .$$

Therefore if P(1) and P(11) are estimated within error O(δ) then the error in [symbol] Λₖ [symbol] ₚₒₛₜ is O(δ/P(1)) since P(1)≥P(11). Therefore [symbol] Λₖ [symbol] ₚₒₛₜ can be estimated to within error ϵ if δ∈O(ϵP(1)/Δλ). Bounds on the cost of amplitude estimation give the cost of this to be:

$$\tilde{O} ( \frac{{Γ}_{E} Δ λ}{ϵ {\sum }_{x} P ( x ) P ( E \vert x )} ) .$$

This shows that if modest relative error (i.e. Δλ∈O(ϵ)) is required, then this process can be highly efficient. In contrast, previous results that do not use these factors that incorporate a priori knowledge of the scale of these terms may not be efficient under such assumptions.

The method can be simple. For fixed L repeat the quantum Bayes update rule L times, without measuring the control qubits. Assume that beyond L iterations the probability of success is too small to continue and then “resample”’ the distribution by learning a model for the distribution using the method disclosed in Grover and Rudolph, “Creating superpositions that correspond to efficiently integrable probability distributions,” arXiv quant-ph/0208112 (2002). This is then used to prepare this distribution as the prior and this process is repeated until the norm of the final covariance matrix is sufficiently small and the expectation value of the posterior distribution is obtained.

Discrete values of x define a grid or mesh that is used to approximate a probability distribution. It can be shown that errors introduced by such discretization tend to be acceptably small, and that only a few qubits are required for stability.

### Approximate Posterior Determinations

There are many methods for preparing states that represent probability distributions using a quantum computer. By the linearity of quantum mechanics, any method of doing so which is coherent can then be used to prepare a mixture distribution such as is used in SMC approximations. As a result, each can be used in a quantum resampling procedure. Perhaps the most straightforward is the method of Grover and Rudolph which provides an efficient algorithm for preparing a probability distribution that is efficiently integrable. Kitaev and Webb have shown that Gaussian states can be efficiently prepared using a quantum computer. However, a simpler class of functions can be used in resampling, and constructed using a quantum Fourier transform. For any non-negative integer k, a quantum computer can prepare a quantum state of the form

$${\sum }_{x = 0}^{{2}^{n} - 1} {e}^{i φ ( x )} \sqrt{P ( x )} \vert x 〉 ,$$

wherein

$$P ( x ) = \frac{{sin}^{2} ( π {2}^{k} x / {2}^{n} )}{{2}^{k + n} {sin}^{2} ( π x / {2}^{n} )} ,$$

using at most O(n log(n/ϵ)) one and two-qubit gates taken from the set {H,P(θ),Λ(P(θ))} where P(θ):|x [symbol] [symbol] e^{2πiθx}|x [symbol] , θ∈{y/2ⁿ:y∈ [symbol] } and Λ(P(θ)) is a control gate counterpart.

This probability distribution can be prepared using the following steps. First, for integer k>0, prepare the state

$$\vert ψ 〉 = \frac{1}{{\sqrt{2}}^{k}} {\sum }_{j = 0}^{{2}^{k} - 1} \vert j 〉$$

using k Hadamard gates. Second, apply the Pauli operator Z=P(½) to the least significant bit in |ψ [symbol] . Third, apply the quantum Fourier transform (QFT) to the result. This produces the required state because applying Z to the least significant qubit in |ψ [symbol] gives:

$$\frac{1}{\sqrt{k}} {\sum }_{j = 0}^{k - 1} {e}^{- i π j} \vert j 〉 . \qquad ( 3 )$$

Using the shift property of discrete Fourier transforms (DFTs), it is clear that this phase shift displaces the Fourier transform to the middle of the spectrum. Then using the shift property of the discrete Fourier transforms again along with the formula for the DFT of a window function gives that:

$$P ( x ) = \frac{{sin}^{2} ( π {2}^{k} x / {2}^{n} )}{{2}^{k + n} {sin}^{2} ( π x / {2}^{n} )} .$$

This formula can also be easily proved using the discrete Fourier transform of the Kronecker—delta function and the linearity of the Fourier transform. The cost of the circuit is dominated by that of the Fourier transform.

There is residual phase present in the quantum state in Eq. 3 because the initial window is not centered at x=0. This can be corrected, if necessary, by using an adder or by applying a phase rotation in Fourier space. The depth of the resulting circuits is small and these circuits can be implemented as circuits over the Clifford+T gate set by incurring a multiplicative cost that is at most O(log(n/ϵ)).

While the disclosed methods are generally unsuited for modeling correlations in many-variable systems, these methods are well suited for modeling posterior distributions as products of independent distributions. For most well posed learning problems, the posterior distribution tends to a unimodal distribution, but there can be difficulties associated bimodal distributions or in the presence of significant correlations. Correlation-based effects can be addressed, in part, by using principal component analysis (PCA) to re-express the problem in an eigenbasis of a covariance matrix in which there are no (or small) correlations. Since the model dimension is generically low, PCA can be considered to be efficient. Quantum techniques can also be used to sample efficiently from the principal components of the distribution.

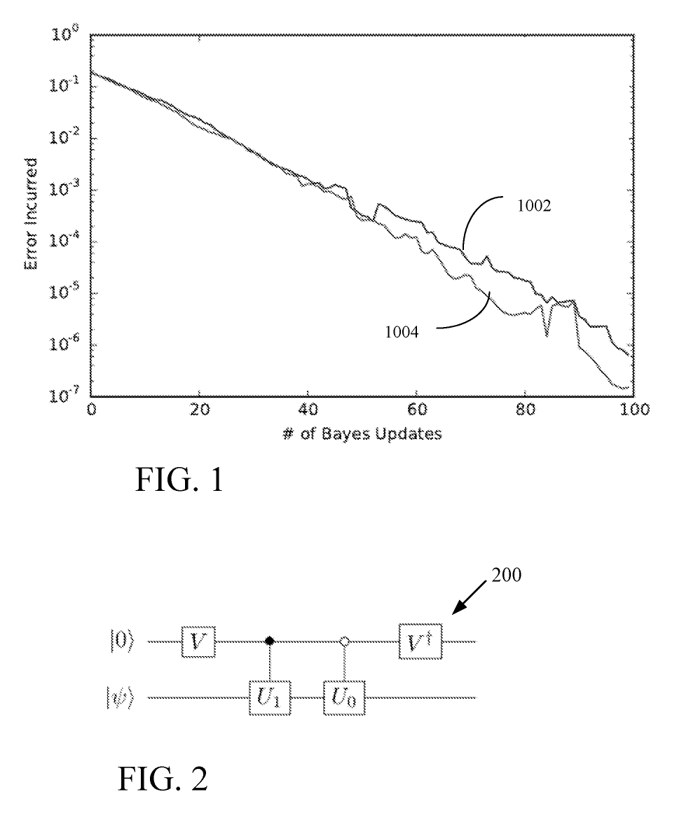

A potential flaw of using sinc-based resampling is that the sinc function has many nodes which will be ascribed zero probability in the initial prior. If the true model happens to reside at, or near, one of these nodes then the updating procedure may accidentally omit the true model during a quantum resampling step. This can be corrected through many approaches, such as resorting to the more computationally expensive Gaussian state preparation, but such correction is generally unnecessary. FIG. 1 illustrates error as a function of a number of Bayes updates for Gaussian resampling (curve 102) and sinc² resampling (curve 104). As is apparent, errors associated with sinc² sampling are about the same or less that those associated with Gaussian sampling. The impact of these nodes can be reduced by using a linear combination of such states. In particular, linear combinations of step functions can be used as initial states, and the resulting combinations Fourier transformed. Linear combinations of states can be prepared using a circuit 200 shown in FIG. 2, wherein U₁, U₀ are unitary quantum operations corresponding to step functions and for some real-valued A≥0,

$$V = ( \begin{matrix}\sqrt{\frac{A}{A + 1}} & - \sqrt{\frac{1}{A + 1}} \\ \sqrt{\frac{1}{A + 1}} & \sqrt{\frac{A}{A + 1}}\end{matrix} )$$

If the top-most qubit is measured to be 0, then the circuit performs the state transformation

$$\vert ψ 〉 \to \frac{( {AU}_{1} + {U}_{0} ) \vert ψ 〉}{\vert ( {AU}_{1} + {U}_{0} ) \vert ψ 〉 \vert}$$

This allows linear combinations of initial states to be prepared from |0 [symbol] with probability

$${P}_{succ} = {\vert \frac{( {AU}_{1} + {U}_{0} ) {\vert 0 〉}^{2}}{A + 1} \vert}^{2} .$$

### Assuming

$${U}_{1} \vert 0 〉 = \frac{1}{\sqrt{{2}^{{k}_{1}}}} {\sum }_{j = 0}^{{2}^{{k}_{1} - 1}} \vert j 〉 and {U}_{2} \vert 0 〉 = \frac{1}{\sqrt{{2}^{{k}_{2}}}} {\sum }_{j = 0}^{{2}^{{k}_{2} - 1}} \vert j 〉$$

for k₂≥k₁ then it is straight forward that a linear combination of two states can be formed with probability

$${P}_{succ} = \frac{{( \frac{A}{\sqrt{{2}^{{k}_{1}}}} + \frac{1}{\sqrt{{2}^{{k}_{2}}}} )}^{2} {k}_{2} + {( \frac{A}{\sqrt{{2}^{{k}_{1}}}} )}^{2} ( {2}^{{k}_{1}} - {2}^{{k}_{2}} )}{{( A + 1 )}^{2}}$$

Since the probability of successfully combining the two unitaries via measurement and post-selection is known, amplitude amplification can be used to make the process deterministic. The probability of success for the case where a polynomial number of terms are summed can also be computed and can be shown to be efficient.

### Filtering Distributions for Time-Dependent Models

In practice, physical systems of interest in physics, financial modeling, computer vision, or other areas are frequently time-dependent. In such cases, the likelihood function P(E|x) is replaced by P(E|x;τ), wherein τ refers to time. There are several approaches suitable for time-dependent likelihoods. For example, additional parameters (hyperparameters) can be introduced that allow temporal variations of likelihood functions to be modeled. Estimation and inference then proceed based on the hyperparameters, rather than on model parameters directly. For instance, letting ω in a periodic likelihood be drawn from a stationary Gaussian process and then marginalizing over a history of the process results in a hyperparameterized likelihood:

$$P ( 1 \vert μ , σ ; {ω}_{-} , t ) = \frac{1}{2} ( {e}^{- \frac{1}{2} {σ}^{2} {t}^{2}} cos ( μ t ) + 1 ) ,$$

wherein μ and σ² are the mean and variance of the Gaussian process.

Using hyperparameters works well for modeling the distribution of the dynamics of a model and can be directly implemented using the methods described previously, but this does not generally permit tracking instantaneous model parameters. A major application of classical SMC algorithms is tracking the positions or time-dependent properties of an object. This application can be challenging because as Bayesian inference proceeds the certainty in the position of the SMC particles tends to increase, but if the true hypothesis drifts, then this will not be represented by Bayes updates alone. This means that the true model can easily drift into a region that is not supported by the prior obtained by previous updates that neglected the stochasticity of the model parameters. This in turn will cause the update to fail, such that the algorithm will no longer be able to track the position of the object.

Quantum rejection sampling can be extended to include diffusion by using a resampling kernel that has a broader variance than that of the accepted posterior samples. Doing so allows quantum rejection sampling to track stochastic processes in a similar way to SMC methods. Thus, using such resampling kernels, the disclosed methods and apparatus can be used with significantly more challenging likelihood functions, including time-varying likelihood functions.

SMC can be made to track stochastically varying model parameters, by incorporating a prediction step that diffuses the model parameters of each particle. As disclosed herein, this approach can be extend to quantum algorithms by performing Bayes updates on quantum Fourier transformed posterior states. This approach can realize the advantages of space complexity even in the presence of time-dependence. In particular, by convolving the prior with a filter function such as a Gaussian, the width of the resultant distribution can be increased without affecting the prior mean. This means that the Bayes estimate of the true model will remain identical while granting the prior the ability to recover from time-variation of the true model parameters. If at each step Bayesian inference causes the posterior variance to contract by a factor of α and convolution with a filter function causes the variance to expand by β, then the variance of the resulting distribution asymptotes to β/(1−α). Thus, α(x) can be prevented from becoming unrealistically small by applying such filtering strategies.

The convolution property of the Fourier transform [symbol] gives for any two functions P and Q, P★Q∝ [symbol] [ [symbol] (P)· [symbol] (Q)] wherein ★ is a circular convolution. Thus, a quantum Fourier transform can therefore be used to convolve an unknown P with a known distribution Q that has an efficiently computable Fourier transform \hat{Q}. This convolution allows the prior distribution to be filtered.

Convolution can be implemented as follows. First, a current posterior is Fourier transformed as:

$$\vert P 〉 := {\sum }_{x} P ( x ) \vert x 〉 ↦ {ℱ}^{•} ( {\sum }_{x} P ( x ) \vert x 〉 ) := {\sum }_{k} {ω}_{k} \vert k 〉 .$$

Then, a Fourier-domain representation of a convolution kernel is prepared as:

$${\sum }_{k} {ω}_{k} \vert k 〉 ↦ {\sum }_{k} {ω}_{k} \vert k 〉 \vert {sin}^{- 1} ( \sqrt{\hat{Q} ( k ) / {Γ}_{E}} ) 〉 .$$

The convolution kernel is updated and transformed back:

$${\sum }_{k} {ω}_{k} \vert k 〉 \vert {sin}^{- 1} ( \sqrt{\hat{Q} ( k ) / {Γ}_{E}} ) 〉 ↦ {{ℱ}^{- 1}}^{•} ( {\sum }_{k} {ω}_{k} \vert k 〉 \vert 0 〉 ( \sqrt{\hat{Q} ( k ) / {Γ}_{E}} \vert 1 〉 + \sqrt{1 - \hat{Q} ( k ) / {Γ}_{E}} \vert 0 〉 ) ) .$$

If 1 is measured, then the result implements circular convolution P★Q. If 0 is measured, the procedure is repeated.

Fourier transform and inverse Fourier transform operation require O(n log(n/ϵ)) gate operations. The Fourier domain representation of the convolution kernel requires only requires query operations. The final step requires O(log(1/ϵ)), controlled rotations each of which can be implemented using a constant number of one- and two-qubit operations to ensure that a rotation on the ancilla qubit is successfully implemented and O(n log(n/ϵ)) gate operations for performing the inverse quantum Fourier transform which involves performing gates. Summing these costs gives O(n log(n/ϵ)). The quoted scaling of the circuit size then follows by multiplying this by the number of attempts needed to achieve a successful result using amplitude amplification.

### Adaptive Experiment Design

Bayesian methods can also be used in an online fashion to design new experiments to perform, given current knowledge about a system of interest. The disclosed quantum computing methods can be used to perform Bayesian experiment design with significant advantages over classical methods. In practice, Bayesian experiment design is often posed in terms of finding experiments which maximize utility function such as an information gain or a reduction in a loss function. Once a utility function is chosen, its argmax can be found by gradient ascent methods provided that the derivatives of the utility function can be computed. In particular, since the reduction in the quadratic loss is given by the posterior variance, the disclosed methods can be used to compute gradients of the corresponding utility function.

Quantum computing can also be used to find the best experiment to perform given the current knowledge of the system. The way this is usually done in practice is to compute the argmax of the utility function, which measures the expected value of a given experiment. This can be estimated using a gradient ascent algorithm given the gradient of the utility function. In order to define the utility the Bayes risk and the loss function are used. For simplicity, all model parameters are assumed to be re-normalized such that x∈[0,1].

Two quantities are defined: a loss function and a Bayes risk. For convenience, it is assumed that model parameters are renormalized such that all components of x lie in [0, 1]. The loss function represents a penalty assigned to errors in estimates of x. Consider a multiparameter generalization of the mean-squared error, the quadratic loss. For an estimate \hat{x}, the quadratic loss is:

[symbol]

(x,\hat{x})=(x−\hat{x})^{T}(x−\hat{x}).

Letting \hat{x} be the Bayesian mean estimator for the posterior P(x|d,c) and considering the single-parameter case,

[symbol]

(x,P(x|d,c))=(x−∫P(x′|d,c)x′dx′)².

The risk is the expectation of the loss over experimental data, L(x,\hat{x})d, wherein \hat{x} is taken to depend on the experimental data. The Bayes risk is then the expectation of risk over both the prior distribution and the outcomes,

$$\begin{matrix}ℛ ( x , P ( x ) ) = L ( x , P ( x \vert d , c ) ) d , x ∼ P ( x ) \\ = \int P ( x ) \int P ( d \vert x , c ) {( x - \int P ( {x}^{′} \vert d , c ) {x}^{′} {dx}^{′} )}^{2} dxdd .\end{matrix}$$

The Bayes risk for the quadratic loss function is thus the trace of the posterior covariance matrix, averaged over possible experimental outcomes. One utility function that can be used to find c that minimizes the Bayes risk is a negative posterior variance, i.e.,

[symbol]

(P(x),c)=−∫P(x)∫P(d|x,c)(x−∫P(x′|d,c)x′dx′)²dxdd. (4)

[symbol]

can be calculated using quantum resources, including in cases where classical methods alone fail. In a finite dimensional setting, integrals are replaced by sums over the corresponding variables. The derivatives of [symbol] can then be approximated for small but finite h as

$$\frac{\partial 𝒰 ( P ( x ) , c )}{\partial {c}_{j}} = \frac{𝒰 ( P ( x ) , c + h {{c}^{•}}_{j} ) - 𝒰 ( P ( x ) , c )}{h} + O ( {h}^{2} ) .$$

Thus if c consists of C different components then O(C) calculations of the utility function are needed to estimate the gradient for a finite value of h.

It can be shown that if |∂ₓ_{ᵢ}ⁿ [symbol] (P(x₁, x₂, . . . ), c)|≤Λⁿ for all experimental configurations c and that there are D experimental outcomes, then each component of the gradient of [symbol] can be computed within error ϵ using on average Õ(ΛCD/ϵ) queries to the likelihood function and the prior.

The utility function can be directly computed on a quantum computer, but doing so can be challenging because of the need to coherently store the posterior means of the distribution. This can be simplified by expanding the square in Eq. 4 as:

[symbol]

(P(x),c)=−∫∫P(x)P(d|x,c)x²dxdd (5a)

+2∫∫∫P(x)P(d|x,c)P(x′|d,c)xx′dx′dddx (5b)

−∫∫∫∫P(x)P(d|x,c)P(x′|d,c)P(x″|d,c)x′x″dx″dx′dddx. (5c)

These terms can be computed individually and the results combined classically to obtain an estimate of [symbol] .

The double integral term Eq. 5a can be computed by preparing the state:

$${\sum }_{x} \sqrt{P ( x )} \vert x 〉 \frac{1}{\sqrt{D}} {\sum }_{d = 1}^{D} \vert d 〉 ( \sqrt{P ( D \vert x , c ) {x}^{2}} \backslash \vert 1 〉 + \sqrt{1 - P ( D \vert x , c ) {x}^{2}} \vert 0 〉 ) .$$

The probability of measuring the right most qubit to be 1 is

$${\sum }_{x} {\sum }_{d} P ( x ) P ( D \vert x , c ) {x}^{2} / D \leq 1 / D .$$

Therefore, the desired probability can be found by estimating the likelihood of observing 1 divided by the total number of outcomes D. A direct application of amplitude estimation shows that the expectation value can be learned within error ϵ using Õ(D/ϵ) preparations of the initial state and evaluations of the likelihood function. Since the probability of success is known to be bounded above by 1/D amplitude amplification can be applied first to boost the probability of success to O(1) and then the desired probability can be inferred from the probability of success for its amplified analog. This results in Õ(\sqrt{D}/ϵ) queries.

The triple integral (5b) is more challenging, and can be expressed as:

$$\int \int \int P ( x ) P ( d \vert x , c ) P ( {x}^{′} \vert d , c ) {xx}^{′} {dx}^{′} dddx = \int \int \int P ( x ) P ( d \vert x , c ) \frac{P ( d \vert {x}^{′} , c ) P ( {x}^{′} )}{{\sum }_{{x}^{′}} P ( d \vert {x}^{′} c ) P ( {x}^{′} )} {xx}^{′} {dx}^{′} dddx . \qquad ( 6 )$$

The integral over din this expression is difficult to compute in superposition. So instead of integrating over d using quantum computations, the integrand is computed using quantum techniques and the integration over d is done classically. In many models D will be small (D=2 is not uncommon) hence a polynomial reduction in the scaling with D will often not warrant the additional costs of amplitude amplification.

For fixed d the first step is to compute

$${\sum }_{x} P ( d \vert x , c ) P ( x ) ,$$

which can be estimated by preparing the state:

$${\sum }_{x} \sqrt{P ( x )} \vert x 〉 ( \sqrt{P ( d \vert x , c )} \vert 1 〉 + \sqrt{1 - P ( d \vert x , c )} \vert 0 〉 ) \qquad ( 7 )$$

and estimating, P_{d}, the probability that the right-most qubit is 1, which is the required probability. The numerator can be estimated in exactly the same fashion, by preparing the state

$${\sum }_{x} \sqrt{P ( x )} \vert x 〉 {\sum }_{{x}^{′}} \sqrt{P ( {x}^{′} )} \vert {x}^{′} 〉 ( \sqrt{P ( d \vert {x}^{′} , c ) P ( d \vert x , c ) {xx}^{′}} \vert 1 〉 + \sqrt{1 - P ( d \vert {x}^{′} , c ) P ( d \vert x , c ) {xx}^{′}} \vert 0 〉 ) ,$$

which can be estimated to within error

$$ϵ {\sum }_{x} P ( x ) P ( d \vert x , c )$$

using Õ(1/ϵP_{d}) queries. Since x≤1, then:

$${\sum }_{x} {\sum }_{{x}^{′}} P ( x ) P ( {x}^{′} ) P ( d \vert x , c ) P ( d \vert {x}^{′} , c ) {xx}^{′} \leq {( {\sum }_{x} P ( x ) P ( d \vert x , c ) )}^{2} = {P}_{d}^{2} .$$

Therefore, if amplitude amplification is used to boost the upper bound on the probability to 1 and then amplitude estimation is used to learn the amplified probability, the average number of queries needed to learn this quantity within the desired accuracy is O(1/ϵ). The classical integration loop requires that we repeat this process D times, and so the resultant complexity is Õ(D/ϵ).

The analysis of the quadruple integral similar and requires Õ(D/ϵ) queries on average. Thus the cost of evaluating the utility function to within error ϵ is O(D/ϵ). This process can also be implemented coherently by using coherent, rather than traditional, amplitude estimation. If coherent amplitude estimation is used, then this algorithm can be viewed as implementing an oracle [symbol] that is implicitly a function of the prior distribution such that:

[symbol]

:|c [symbol] |0 [symbol] [symbol] |c [symbol] | [symbol] (P(x),c) [symbol] .

The gradient of this operator can be directly computed using O(C) queries. Note that this cannot be trivially reduced to one query using Jordan's algorithm for the gradient (found in Jordan, Phys. Rev. Lett. 95:05051 (2005)) because Monte-Carlo error in coherent amplitude estimation violates the continuity assumptions required by this algorithm.

Instead of using quantum methods for gradient evaluation, high-order formulas for the derivative can be used that are based on interpolation methods. These methods require n+1 points in a mesh of spacing h in order to provide an approximation that has error O(hⁿ). In particular, if these formulas are applied to the gradient in the absence of Monte-Carlo error, then the error is:

$$O ( Λ \frac{{( Λ h )}^{n}}{( n + 1 ) !} ) .$$

This means that if the error in the calculation of any component of the gradient to be C, then it suffices to pick

$$h ∈ Θ ( \frac{1}{Λ} {( \frac{ϵ ( n + 1 ) !}{Λ} )}^{1 / n} ) . \qquad ( 8 )$$

From the triangle inequality, the total error is at most the sum of the error from using the derivative formula on the exact utility function and the error that results from Monte-Carlo approximation. The approximate formula consists of O(n) points each of which is evaluated to within error O(ϵ) and hence the overall error from Monte-Carlo approximation is:

$$O ( \frac{n ϵ}{h} ) .$$

Thus h→0 cannot be used to evaluate the derivative accurately in the presence of finite ϵ. Taking h according to Eq. 8, then the error is

$$\tilde{O} ( {ϵΛ ( \frac{Λ}{ϵ} )}^{1 / n} ) .$$

If nϵO(log(Λ/ϵ)), then the multiplicative term in the error is at most constant resulting in error Õ(ϵΛ). Thus ϵ→ϵ/Λ in order to hit a desired error tolerance. Therefore, neglecting the cost of sub-polynomial multiplicative terms, the number of queries needed to estimate the gradient to within this accuracy is Õ(ΛD/ϵ). Since there are C such components, the total cost of the gradient calculation is Õ(ΛCD/ϵ).

This shows that quantum techniques can achieve a polynomial speedup over classical methods for computing the gradient using sampling, which would require O(ΛCD/ϵ²) queries. A feature of this approach is that a qubit string representation for the likelihood is need not be used explicitly to prepare states such as shown in Eq. 7. Similar states could also be prepared for problems such as quantum Hamiltonian learning (see Wiebe et al., Phys. Rev. Lett. 112:190501 (2014)) by eschewing a digital oracle and instead using a quantum simulation circuit that marks parts of the quantum state that correspond to measurement outcome d being observed. This means that these algorithms can be used in concert with quantum Hamiltonian learning ideas to efficiently optimize experimental design, whereas no efficient classical method exists to do so because of the expense of simulation

### Overview Summary

The novel approaches to quantum Bayesian inference discussed above can address the problems faced by other quantum methods: namely their inefficiency in cases where P(E)= [symbol] P(x), P(E|x) [symbol] is exponentially small. Using an approximate form of inference where a concise model of a posterior distribution is obtained, rather than the whole distribution, learning can continue in spite of failures in quantum rejection sampling because a known prior distribution is maintained to fall back on. A particular class of unimodal distributions that can be constructed using a quantum computer is also described and can serve as a model for the prior. In addition, the disclosed approaches can be used with time dependent data. Finally, quantum computers can be used to speed up adaptive experiment design by facilitating evaluation of derivatives of a loss function, allowing for efficient experiment optimization for quantum Hamiltonian learning.

### REPRESENTATIVE EMBODIMENTS

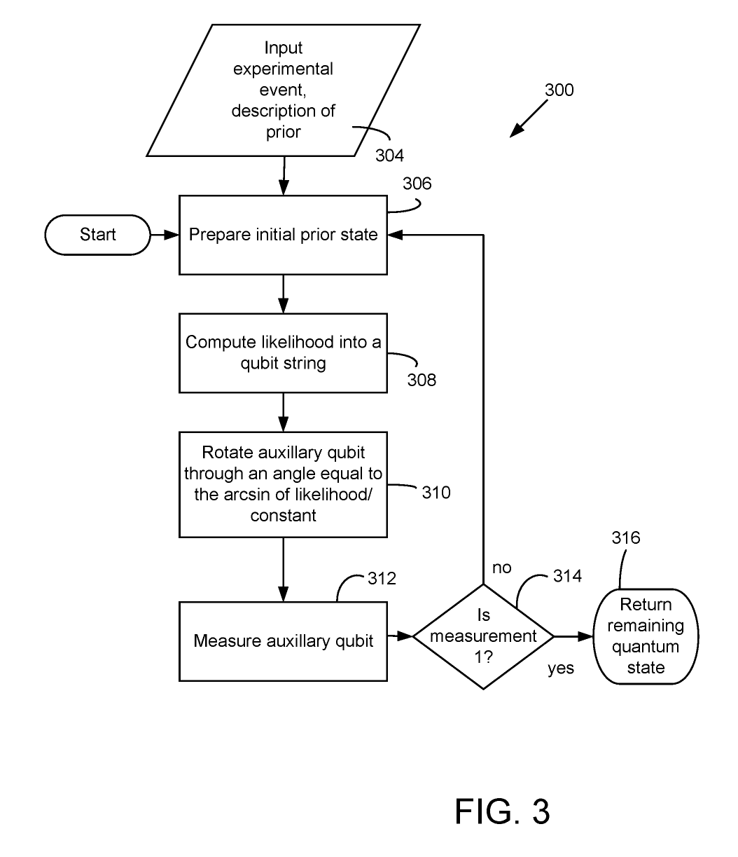

Referring to FIG. 3, a method 300 of quantum rejection sampling includes inputting an experimental result and a prior (or description thereof) at 304. An initial prior state is prepared at 306, and a likelihood is computed into a qubit string at 308. At 310, an auxiliary qubit is rotated through an angle based on the inverse sine of the likelihood. The auxiliary qubit is measured at 312. If the measurement returns 0 as determined at 314 (corresponding to failure or rejection), then the initial state preparation at 306 is repeated, along with the sequence 308, 310, 312. If the measurement returns 1, a remaining quantum state is returned at 316. The remaining quantum state corresponds to the state associated with non-measured qubits, i.e., qubits other than the auxiliary qubit(s) and is associated with an updated likelihood.

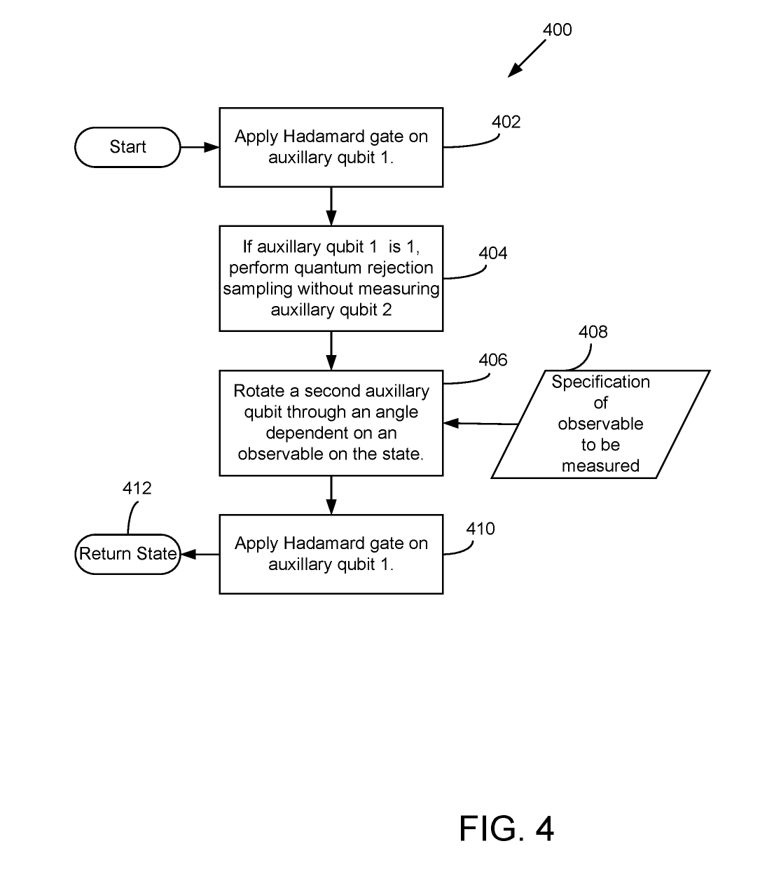

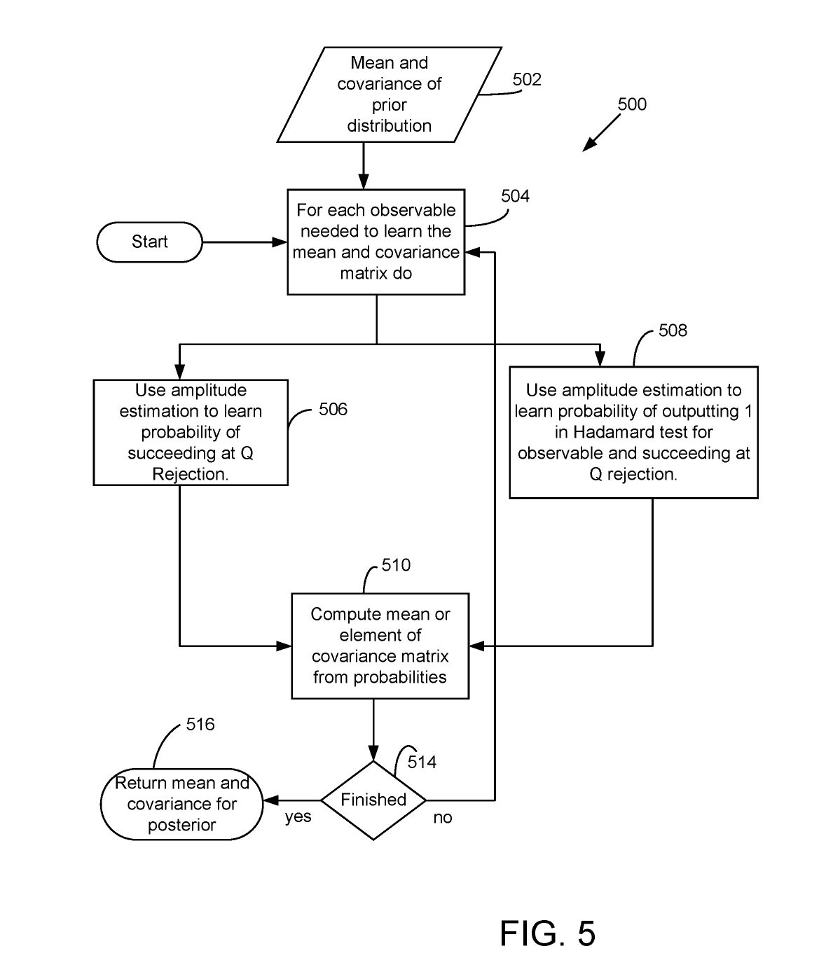

With reference to FIG. 4, a Hadamard test procedure 400 includes applying a Hadamard gate to an auxiliary qubit at 402, for example, a first auxiliary qubit. At 404, quantum rejection sampling is performed without measurement of an auxiliary qubit, for example, a second auxiliary qubit. At 406, the second auxiliary qubit is rotated through an angle based on a specified observable of the state that is provided at 408. At 410, a Hadamard gate is applied on the first auxiliary qubit. At 412, a state is returned.

An approximate update method 500 as illustrated in FIG. 5 includes obtaining a mean and/or covariance of a prior distribution at 502. At 504, processing of each observable used to obtain the mean and covariance is initiated. At 506, a probability of succeeding at quantum rejection is obtained using amplitude estimation and at 508, amplitude estimation is used to learn a probability of outputting 1 in a Hadamard test for the selected observable and succeeding at quantum rejection. At 510, a mean or an element of a covariance matrix is determined based on the probabilities. At 514, it is determined if all observables have been processed. If not, processing continues at 504. Otherwise, at 516, a mean and/or a covariance are returned for a posterior.

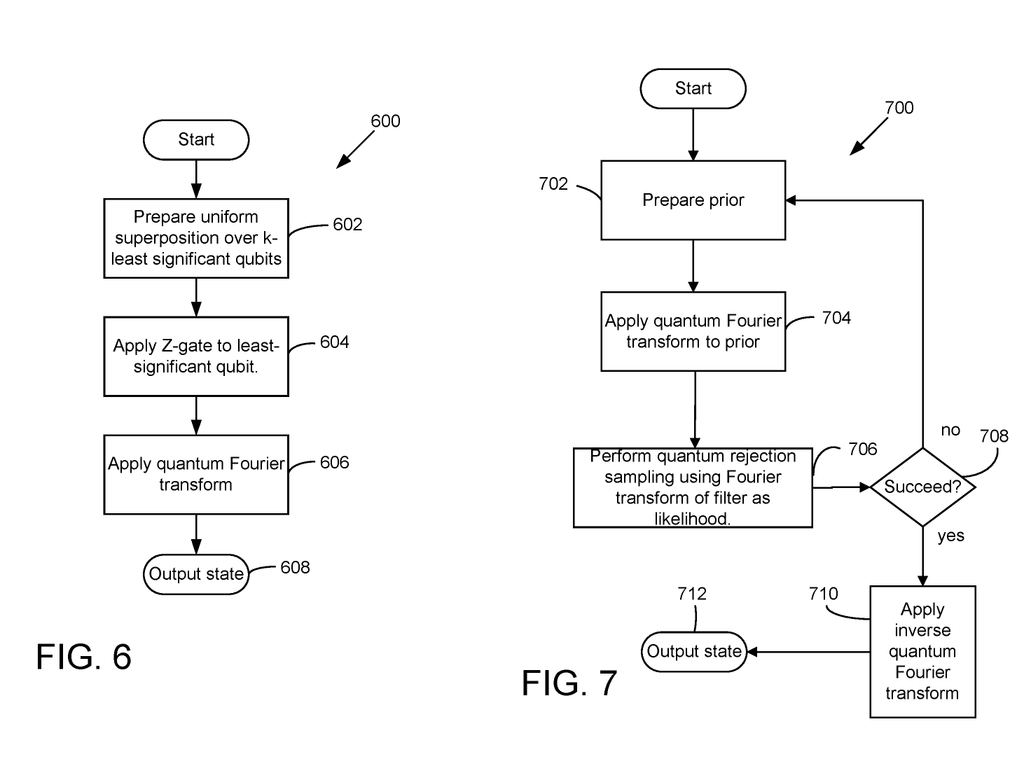

A sinc function state preparation method 600 is illustrated in FIG. 6. At 602, a uniform superposition over k least significant qubits is prepared. At 604, a Z-gate is applied to a least significant qubit. A quantum Fourier transform is applied at 606, and state associated with a sinc function state is output at 608.

With reference to FIG. 7, a filter method 700 that is suitable for time-dependent inference includes preparing a state corresponding to a prior at 702. At 704, quantum Fourier transform is applied to the state. At 706, quantum rejection sampling is performed using a Fourier transform of a filter as a likelihood. If quantum rejection is successful as determined at 708, an inverse quantum Fourier transform is applied at 710 and the resulting state is output at 712.

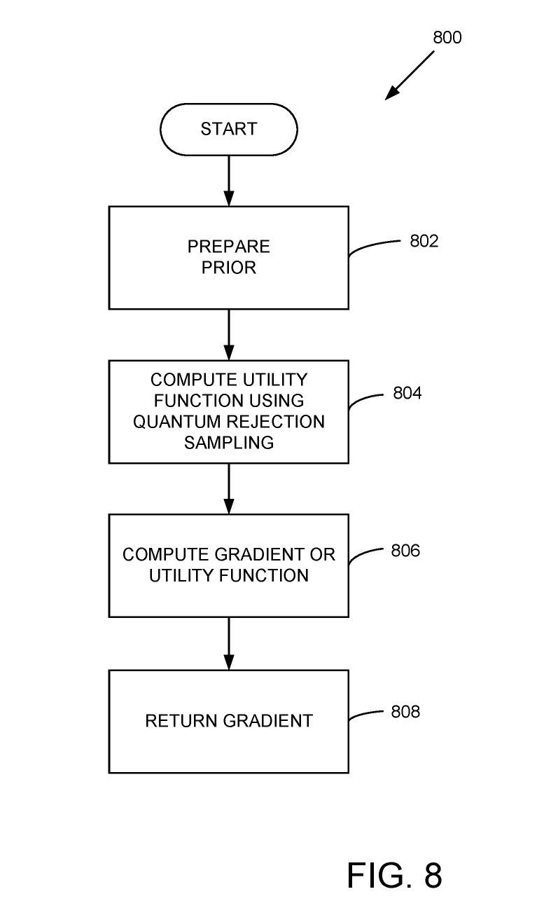

FIG. 8 illustrates a method 800 of computing a gradient of a utility function using quantum rejection sampling. At 802 a prior is prepared and at 804, a utility function is computed using quantum rejection sampling, typically using all available experiment outcomes. At 806 a gradient of the utility function is determined classically based on computed values of the utility function and returned at 808.

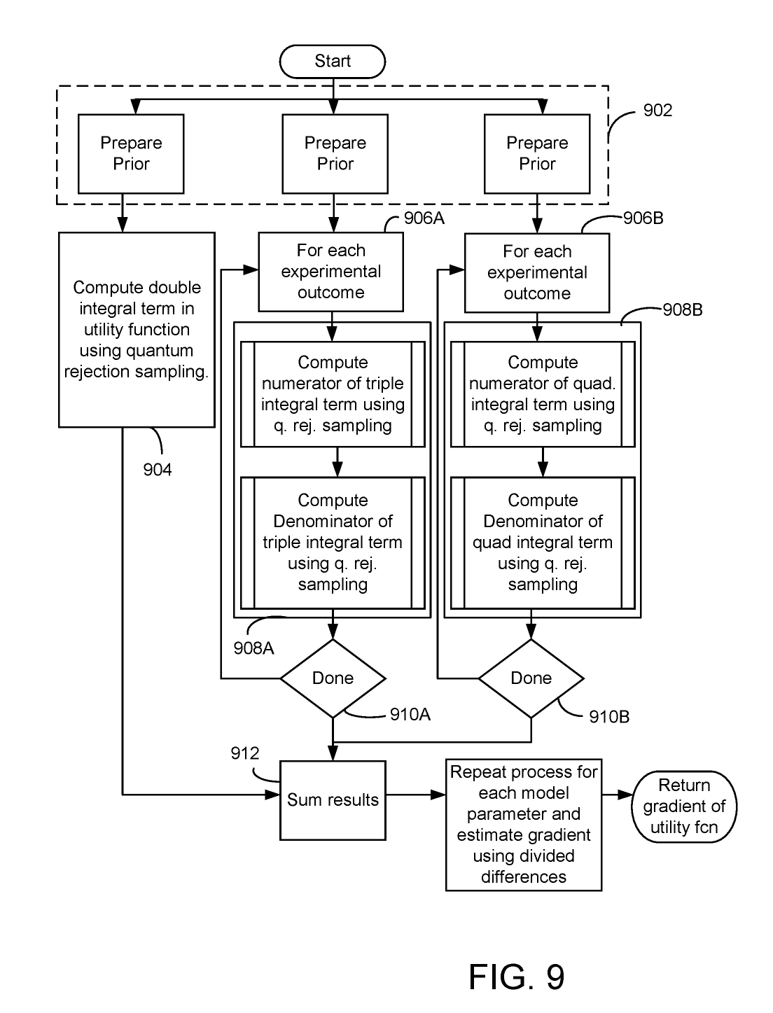

A particular example of utility function determination is illustrated in FIG. 9. At 902, a prior is prepared. In this example, the utility function of Eqs. 5a-5c is used. At 904, a double integral term shown in Eq. 5a is computed using quantum rejection sampling. At 906A, 906B, an experimental outcome is selected and a triple integral term shown in Eq. 5b and a quadruple integral term shown in Eq. 5c are computed using quantum rejection sampling at 908A, 908B respectively. At 910A, 910B, it is determined if additional experimental outcomes are available. If so, 906A, 906B, 908A, 908B are repeated. If all (or selected) experimental outcomes have been used, the double, triple, and quadruple integral terms are summed (classically) at 912. At 914, this procedure is repeated for all (or selected) model parameters and a gradient of the utility function is estimated using divided differences. At 916, a gradient of the utility function is returned.

### Representative Quantum and Classical Systems

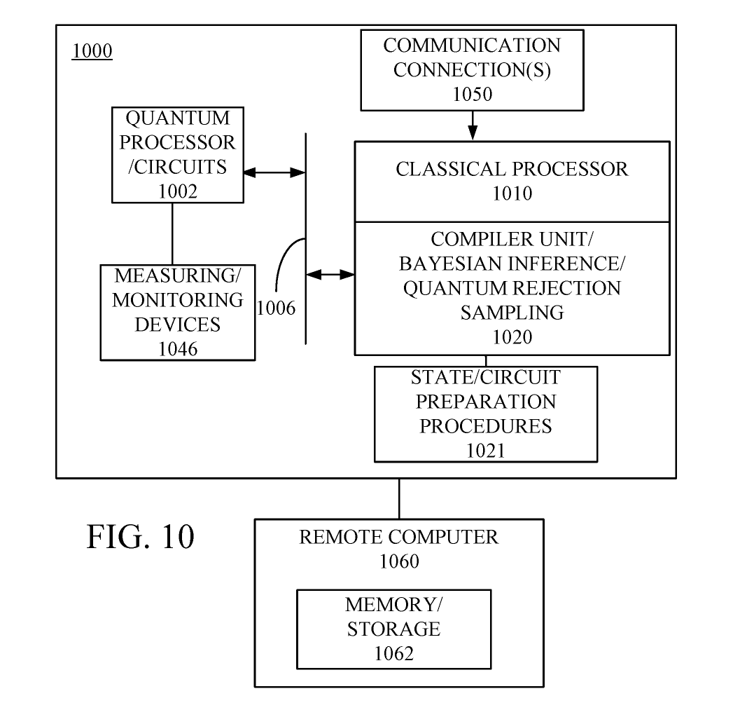

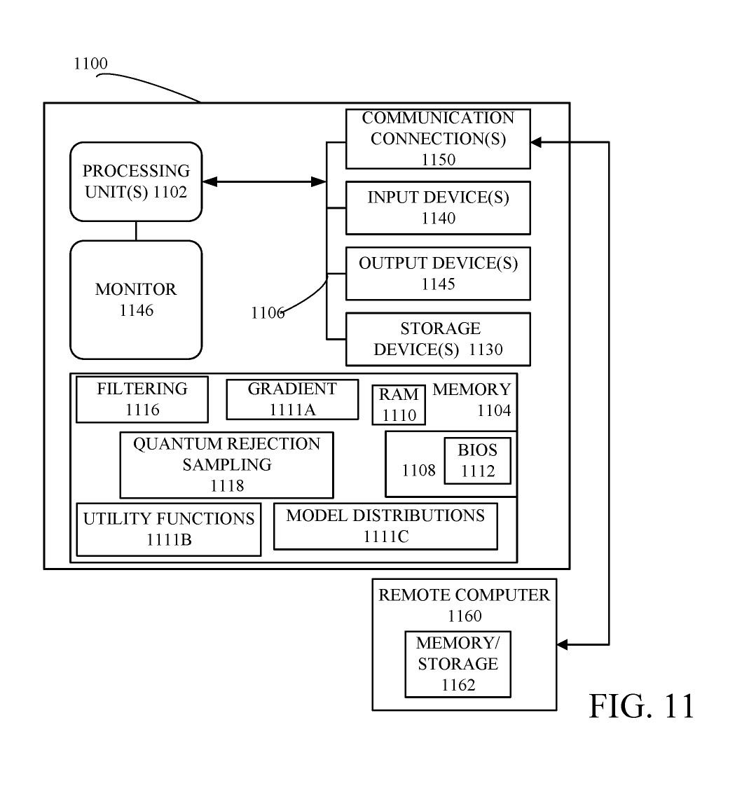

With reference to FIG. 10, an exemplary system for implementing some aspects of the disclosed technology includes a computing environment 1000 that includes a quantum processing unit 1002 and one or more monitoring/measuring device(s) 1046. The quantum processor executes quantum circuits (such as the circuit of FIG. 2) that are precompiled by classical compiler unit 1020 utilizing one or more classical processor(s) 1010.

With reference to FIG. 10, the compilation is the process of translation of a high-level description of a quantum algorithm into a sequence of quantum circuits. Such high-level description may be stored, as the case may be, on one or more external computer(s) 1060 outside the computing environment 1000 utilizing one or more memory and/or storage device(s) 1062, then downloaded as necessary into the computing environment 1000 via one or more communication connection(s) 1050. Alternatively, the classical compiler unit 1020 is coupled to a classical processor 1010 and a procedure library 1021 that contains some or all procedures or data necessary to implement the methods described above such as quantum rejection sampling, quantum Fourier transforms, sinc function preparation and, state measurements. The procedure library 1021 can contain instructions for both quantum and classical computation procedures and circuits, or separate libraries can be provided.

FIG. 11 and the following discussion are intended to provide a brief, general description of an exemplary computing environment in which the disclosed technology may be implemented. Although not required, the disclosed technology is described in the general context of computer executable instructions, such as program modules, being executed by a personal computer (PC). Generally, program modules include routines, programs, objects, components, data structures, etc., that perform particular tasks or implement particular abstract data types. Moreover, the disclosed technology may be implemented with other computer system configurations, including hand held devices, multiprocessor systems, microprocessor-based or programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules may be located in both local and remote memory storage devices. Typically, a classical computing environment is coupled to a quantum computing environment, but a quantum computing environment is not shown in FIG. 11.

With reference to FIG. 11, an exemplary system for implementing the disclosed technology includes a general purpose computing device in the form of an exemplary conventional PC 1100, including one or more processing units 1102, a system memory 1104, and a system bus 1106 that couples various system components including the system memory 1104 to the one or more processing units 1102. The system bus 1106 may be any of several types of bus structures including a memory bus or memory controller, a peripheral bus, and a local bus using any of a variety of bus architectures. The exemplary system memory 1104 includes read only memory (ROM) 1108 and random access memory (RAM) 1110. A basic input/output system (BIOS) 1112, containing the basic routines that help with the transfer of information between elements within the PC 1100, is stored in ROM 1108.

As shown in FIG. 11, computer executable instructions and associated procedures and data are stored in a memory portion 1116. Instructions for gradient determination and evaluation are stored at 1111A. Model distributions are stored at 1111C, utility function specifications are stored at 1111B, and processor-executable instructions for implementing quantum rejection sampling on a quantum computer are stored at 1118.

The exemplary PC 1100 further includes one or more storage devices 1130 such as a hard disk drive for reading from and writing to a hard disk, a magnetic disk drive for reading from or writing to a removable magnetic disk, and an optical disk drive for reading from or writing to a removable optical disk (such as a CD-ROM or other optical media). Such storage devices can be connected to the system bus 1106 by a hard disk drive interface, a magnetic disk drive interface, and an optical drive interface, respectively. The drives and their associated computer readable media provide nonvolatile storage of computer-readable instructions, data structures, program modules, and other data for the PC 1100. As used herein, computer-readable media does not include propagated signals. Other types of computer-readable media which can store data that is accessible by a PC, such as magnetic cassettes, flash memory cards, digital video disks, CDs, DVDs, RAMs, ROMs, and the like, may also be used in the exemplary operating environment.

A number of program modules may be stored in the storage devices 1130 including an operating system, one or more application programs, other program modules, and program data. Computer-executable instructions for classical procedures and for configuring a quantum computer can be stored in the storage devices 1130 as well as or in addition to the memory 1104. A user may enter commands and information into the PC 1100 through one or more input devices 1140 such as a keyboard and a pointing device such as a mouse. Other input devices may include a digital camera, microphone, joystick, game pad, satellite dish, scanner, or the like. These and other input devices are often connected to the one or more processing units 1102 through a serial port interface that is coupled to the system bus 1106, but may be connected by other interfaces such as a parallel port, game port, or universal serial bus (USB). A monitor 1146 or other type of display device is also connected to the system bus 1106 via an interface, such as a video adapter. Other peripheral output devices 1145, such as speakers and printers (not shown), may be included.

The PC 1100 may operate in a networked environment using logical connections to one or more remote computers, such as a remote computer 1160. In some examples, one or more network or communication connections 1150 are included. The remote computer 1160 may be another PC, a server, a router, a network PC, or a peer device or other common network node, and typically includes many or all of the elements described above relative to the PC 1100, although only a memory storage device 1162 has been illustrated in FIG. 11. The personal computer 1100 and/or the remote computer 1160 can be connected to a logical a local area network (LAN) and a wide area network (WAN). Such networking environments are commonplace in offices, enterprise wide computer networks, intranets, and the Internet.

When used in a LAN networking environment, the PC 1100 is connected to the LAN through a network interface. When used in a WAN networking environment, the PC 1100 typically includes a modem or other means for establishing communications over the WAN, such as the Internet. In a networked environment, program modules depicted relative to the personal computer 1100, or portions thereof, may be stored in the remote memory storage device or other locations on the LAN or WAN. The network connections shown are exemplary, and other means of establishing a communications link between the computers may be used.

In some examples, a logic device such as a field programmable gate array, other programmable logic device (PLD), an application specific integrated circuit can be used, and a general purpose processor is not necessary. As used herein, processor generally refers to logic devices that execute instructions that can be coupled to the logic device or fixed in the logic device. In some cases, logic devices include memory portions, but memory can be provided externally, as may be convenient. In addition, multiple logic devices can be arranged for parallel processing.

### Features

Different embodiments may include one or more of the inventive features shown in the following table of features.

| | |
|---|---|
| # | Feature |

A. Innovations in Bayes Estimation and Quantum Rejection Sampling

| | |
|---|---|
| A1 | A method, comprising: |
| | (a) preparing a quantum state corresponding to a current posterior; |
| | (b) transforming the quantum state so as to produce a qubit string |
| | corresponding to a likelihood associated with the prior, the qubit string including |
| | at least one auxiliary qubit; |
| | (c) applying a rotation operation to the qubit string so that a state of the at |
| | least one auxiliary qubit is a superposition of a first state and a second state; |
| | (d) measuring the at least one auxiliary qubit, and if the measurement |
| | corresponds to the first state, determining a Bayesian update based on the aubit |
| | string; and |
| | (e) outputting a classical model for the posterior quantum state. |
| A2 | The method of A1, wherein the model for the posterior distribution is a |
| | function of the mean and/or the covariance matrix associated with the posterior |
| | distribution. |
| A3 | The method of any of A1-A2, wherein the Bayesian update corresponds |
| | to a model. |
| A4 | The method of any of A1-A3, further comprising repeating steps (b)-(d) |
| | for a set of measured data. |
| A5 | The method of any of A1-A4, wherein the state of the qubit string if the |
| | measurement corresponds to the first state is $\frac{{\sum }_{x} \sqrt{P ( x ) P ( E \vert x )} \vert x 〉}{\sqrt{{\sum }_{x} P ( x ) P ( E \vert X )}} ,$ |
| | wherein P(x) is a probability of a model x, and P(E\|x) is a likelihood function based |
| | on measured data E. |
| A6 | The method of any of A1-A5, wherein the posterior model corresponds |
| | to a Gaussian distribution. |
| A7 | The method of any of A1-A6, wherein the posterior model corresponds |
| | to a sinc function. |
| A8 | 8. The method of A1-A7, wherein the sinc function corresponds to |
| | $\frac{{sin}^{2} ( {π2}^{k} x \text{/} {2}^{n} )}{{2}^{k + n} {sin}^{2} ( π x \text{/} {2}^{n} )} .$ |
| A9 | The method of any of A1-A9, further comprising preparing a quantum |
| | state corresponding to the sinc function by: |
| | preparing a state $\vert ψ 〉 = \frac{1}{{\sqrt{2}}^{k}} {\sum }_{j = 0}^{{2}^{k} - 1} \vert j 〉$ using k Hadamard gates for an integer |
| | K > 0,; |
| | applying a Pauli operator Z = P(1/2) to a least significant bit in \|ψ [symbol] ; |
| | and |
| | applying a quantum Fourier transform. |
| A10 | The method of any of A1-A9, further comprising updating the model of |
| | the posterior distribution by: |
| | using amplitude estimation to obtain a probability of successful quantum |
| | rejection sampling and a probability of obtaining a predetermined output in |
| | response to a Hadamard test; |
| | determining an updated mean or covariance matrix based on the |
| | probabilities. |
| A11 | The method of any of A1-A10, wherein the Bayesian update corresponds |
| | to a mean or covariance matrix associated with the prior model, and further |
| | comprising: |
| | obtaining an estimate of at least a porition of a utility function using |
| | quantum rejection sampling; |
| | obtaining an estimate of a gradient of the utility function using a classical |
| | computer; and |
| | determining at least one subsequent measurement based on the estimate |
| | of the gradient. |
| A12 | The method of any of A1-A11, wherein the loss function is a quadratic |
| | loss function, and at least one subsequent measurement is selected to reduce the |
| | expectation value of the quadratic loss function. |
| A13 | The method of any of A1-A12, further comprising: |
| | (i) preparing the qubit register to represent the current posterior by: |
| | preparing a state $\vert ψ 〉 = \frac{1}{{\sqrt{2}}^{k}} {\sum }_{j = 0}^{{2}^{k} - 1} \vert j 〉$ using k Hadamard gates for an |
| | integer k > 0,; |
| | applying a Pauli operator Z = P(1/2) to a least significant bit in |
| | \|ψ [symbol] ; and |
| | applying a quantum Fourier transform; |
| | (ii) if the measurement corresponds to the first state, determining the |
| | Bayesian update based on the qubit string, wherein the quantum state |
| | corresponds to a prior model; and |
| | (iii) if the measurement corresponds to a second state, repeating (i) until |
| | the measurement corresponds to the first state, wherein the resultant quantum |
| | state corresponds to an updated posterior. |

B. Innovations in Quantum Bayes Estimation

| | |
|---|---|
| B1 | A method, comprising: |
| | (a) preparing a qubit register so as to represent a current posterior; |
| | (b) applying a quantum Fourier transform to the qubit register; |
| | (c) processing the Fourier-transformed qubit register to obtain a quantum |
| | state corresponding to a product with a Fourier transform of a predetermined |
| | distribution; |
| | (d) applying an inverse Fourier transform to the product and measuring a |
| | selected qubit of the Fourier transformed product; and |
| | (e) wherein if the measurement circuit indicates that the selected qubit is |
| | in a first state based on the measurement, representing a convolution of the |
| | current posterior and the predetermined distribution with the measured Fourier |
| | transformed product; |
| | (f) processing the resultant quantum state to obtain an updated current posterior. |
| B2 | The method of B1, wherein the predetermined distribution is a Gaussian |
| | distribution. |
| B3 | The method of any of B1-B2, wherein the updated current posterior is |
| | obtained by quantum rejection sampling. |
| B4 | The method of any of B1-B3, wherein if the measurement circuit |
| | indicates a second state of the selected qubit, repeating (a)-(e) until the |
| | measurement circuit indicates the first state, and processing the measured |
| | Fourier transformed product corresponding the measurement of the first state to |
| | obtain an updated current posterior. |

C. Innovations in Quantum Computers

| | |
|---|---|
| C1 | A quantum computer, comprising: |
| | a qubit register situated to store a quantum state corresponding an input |
| | posterior distribution; |
| | a measurement circuit coupled to a selected qubit of the qubit register, |
| | a rotation gate coupled so as to rotate a state of the selected qubit through |
| | an angle proportional to the posterior, wherein if the measurement circuit reports |
| | that the selected qubit is in a first state when the qubit register corresponds to an |
| | updated posterior. |
| C2 | The quantum computer of C1, further comprising Hadamard gates, a |
| | Pauli gate, and gates corresponding to a quantum Fourier transform arranged to |
| | produce an estimate of the input posterior. |
| C3 | The quantum computer of any of C1-C2, wherein the angle of rotation is |
| | proportional to a ratio of the posterior to a constant selected to be greater than or |
| | equal to the posterior and less than or equal to one. |

1.-13. (canceled)

14. A method, comprising:
(a) preparing a quantum state corresponding to a current posterior;
(b) transforming the quantum state so as to produce a qubit string corresponding to a likelihood associated with the prior, the qubit string including at least one auxiliary qubit;
(c) applying a rotation operation to the qubit string so that a state of the at least one auxiliary qubit is a superposition of a first state and a second state;
(d) measuring the at least one auxiliary qubit, and if the measurement corresponds to the first state, determining a Bayesian update based on the qubit string; and
(e) outputting a classical model for the posterior quantum state.

15. The method of claim 14, wherein the model for the posterior distribution is a function of the mean and/or the covariance matrix associated with the posterior distribution.

16. The method of claim 14, wherein the Bayesian update corresponds to a model.

17. The method of claim 14, further comprising repeating steps (b)-(d) for a set of measured data.

18. The method of claim 14, wherein the state of the qubit string if the measurement corresponds to the first state is
$$\frac{{Σ}_{x} \sqrt{p ( x ) p ( E \vert x )} \vert x )}{\sqrt{{Σ}_{x} p ( x ) p ( e \vert x )}} ,$$
wherein P(x) is a probability of a model x, and P(E|x) is a likelihood function based on measured data E.

19. The method of claim 14, wherein the posterior model corresponds to a Gaussian distribution.

20. The method of claim 14, wherein the posterior model corresponds to a sinc function.

21. The method of claim 20, wherein the sinc function corresponds to
$$\frac{{sin}^{2} ( {π2}^{k} x / {2}^{n} )}{{2}^{k + n} {sin}^{2} ( π x / {2}^{n} )} .$$

22. The method of claim 21, further comprising preparing a quantum state corresponding to the sinc function by:
preparing a state
$$\vert ψ 〉 = \frac{1}{\sqrt{{2}^{k}}} {\sum }_{j = 0}^{{2}^{k} - 1} \vert j 〉$$
using k Hadamard gates for an integer k>0;
applying a Pauli operator Z=P(½) to a least significant bit in |ψ [symbol] ; and
applying a quantum Fourier transform.

23. The method of claim 15, further comprising updating the model of the posterior distribution by:
using amplitude estimation to obtain a probability of successful quantum rejection sampling and a probability of obtaining a predetermined output in response to a Hadamard test;
determining an updated mean or covariance matrix based on the probabilities.

24. The method of claim 14, wherein the Bayesian update corresponds to a mean or covariance matrix associated with the prior model, and further comprising:
obtaining an estimate of at least a portion of a utility function using quantum rejection sampling;
obtaining an estimate of a gradient of the utility function using a classical computer; and
determining at least one subsequent measurement based on the estimate of the gradient.

25. The method of claim 23, wherein the loss function is a quadratic loss function, and at least one subsequent measurement is selected to reduce the expectation value of the quadratic loss function.

26. The method of claim 22, further comprising:
(i) preparing the qubit register to represent the current posterior by:
preparing a state
$$\vert ψ 〉 = \frac{1}{\sqrt{{2}^{k}}} {\sum }_{j = 0}^{{2}^{k} - 1} \vert j 〉$$
using k Hadamard gates for an integer k>0;
applying a Pauli operator Z=P(½) to a least significant bit in |ψ [symbol] ; and
applying a quantum Fourier transform;
(ii) if the measurement corresponds to the first state, determining the Bayesian update based on the qubit string, wherein the quantum state corresponds to a prior model; and
(iii) if the measurement corresponds to a second state, repeating (i) until the measurement corresponds to the first state, wherein the resultant quantum state corresponds to an updated posterior.

27. A method, comprising:
(a) preparing a qubit register so as to represent a current posterior;
(b) applying a quantum Fourier transform to the qubit register;
(c) processing the Fourier-transformed qubit register to obtain a quantum state corresponding to a product with a Fourier transform of a predetermined distribution;
(d) applying an inverse Fourier transform to the product and measuring a selected qubit of the Fourier transformed product; and
(e) wherein if the measurement circuit indicates that the selected qubit is in a first state based on the measurement, representing a convolution of the current posterior and the predetermined distribution with the measured Fourier transformed product;
(f) processing the resultant quantum state to obtain an updated current posterior.

28. The method of claim 27, wherein the predetermined distribution is a Gaussian distribution.

29. The method of claim 27, wherein the updated current posterior is obtained by quantum rejection sampling.

30. The method of claim 28, wherein if the measurement circuit indicates a second state of the selected qubit, repeating (a)-(e) until the measurement circuit indicates the first state, and processing the measured Fourier transformed product corresponding the measurement of the first state to obtain an updated current posterior.

31. A quantum computer, comprising:
a qubit register situated to store a quantum state corresponding an input posterior distribution;
a measurement circuit coupled to a selected qubit of the qubit register;
a rotation gate coupled so as to rotate a state of the selected qubit through an angle proportional to the posterior, wherein if the measurement circuit reports that the selected qubit is in a first state when the qubit register corresponds to an updated posterior.

32. The quantum computer of claim 30, further comprising Hadamard gates, a Pauli gate, and gates corresponding to a quantum Fourier transform arranged to produce an estimate of the input posterior.

33. The quantum computer of claim 31, wherein the angle of rotation is proportional to a ratio of the posterior to a constant selected to be greater than or equal to the posterior and less than or equal to one.
